(19) United States
(12) Patent Application Publication
(10) Pub. No.: US 2013/0098197 A1
(43) Pub. Date: Apr. 25, 2013

(54) Crank Assembly for Acrobatic Bicycle

(71) Applicant: Chun-Liang Chen, Xihu Township (TW)

(72) Inventor: Chun-Liang Chen, Xihu Township (TW)

(21) Appl. No.: 13/280,542

(22) Filed: Oct. 25, 2011

(51) Int. Cl. B62M 3/00

(52) U.S. Cl. 74/594.2

(57) ABSTRACT

A crank assembly for an acrobatic bicycle includes a mandrel, two cranks, a chainwheel, and a connector. The chainwheel has a shaft hole and a fixing hole. The connector has a mounting hole and a locking hole connected with the shaft hole and the fixing hole respectively. The mounting hole has a mounting portion inserted into the shaft hole. The mounting hole has an engaging surface. The mandrel has two urging portions, and one of the urging portions is extended through the mounting hole and is engaged with the engaging surface. Thus, the connector is connected with the chainwheel and located between the chainwheel, the mandrel and one of the cranks to enhance the structural strength of combination of the chainwheel, the mandrel and the two cranks.

### BACKGROUND OF THE INVENTION

1. Field of the Invention

The present invention relates to a crank assembly and, more particularly, to a crank assembly for an acrobatic bicycle.

2. Description of the Related Art

A conventional crank assembly for an acrobatic bicycle in accordance with the prior art shown in FIGS. 4 and 5 comprises a mandrel 51, two cranks 52 mounted on the mandrel 51, and a chainwheel 50 mounted on the mandrel 51 and connected with one of the two cranks 52. The chainwheel 50 has a central portion provided with a shaft hole 501 and has a periphery provided with a fixing hole 502. Each of the two cranks 52 has an end portion mounted on the mandrel 51. Each of the two cranks 52 has a side provided with a screw bore 521. The conventional crank assembly further comprises a screw member 522 extended through the fixing hole 502 of the chainwheel 50 and screwed into the screw bore 521 of one of the two cranks 52 to combine the chainwheel 50 with one of the two cranks 52. Thus, when the two cranks 52 are rotated by a user, the chainwheel 50 is directly driven by rotation of the two cranks 52 and can be rotated forward and backward reciprocally so as to perform various acrobatic skills by the user. However, the chainwheel 50 is only combined with one of the two cranks 52 by the screw member 522 so that the structural strength of the combination of the chainwheel 50, the mandrel 51 and one of the two cranks 52 is weak. Thus, when the screw member 522 is unscrewed and loosened from the screw bore 521 of one of the two cranks 52 during long-term operation and rotation, the chainwheel 50 is easily vibrated or will be detached from one of the two cranks 52, thereby greatly causing inconvenience or danger to the user.

### BRIEF SUMMARY OF THE INVENTION

In accordance with the present invention, there is provided a crank assembly, comprising a mandrel, two cranks mounted on the mandrel, a chainwheel mounted on the mandrel and located between the two cranks, and a connector mounted on the mandrel and located between the chainwheel and one of the two cranks. The chainwheel has a central portion provided with a shaft hole and has a periphery provided with a fixing hole. The connector has a first end provided with a mounting hole connected with the shaft hole of the chainwheel and a second end provided with a locking hole connected with the fixing hole of the chainwheel. The locking hole of the connector has a diameter smaller than that of the mounting hole. The mounting hole of the connector has a side provided with a protruding mounting portion inserted into the shaft hole of the chainwheel. The mounting hole of the connector has a peripheral wall provided with a successively serrated engaging surface extending through the mounting hole and the mounting portion. Thus, the connector is directly connected with the chainwheel and located between the chainwheel, the mandrel and one of the two cranks to enhance a structural strength of combination of the chainwheel, the mandrel and the two cranks and to decrease cost of the crank assembly.

The mandrel has two successively serrated urging portions formed on two opposite ends thereof One of the two urging portions of the mandrel is extended through the mounting portion and the mounting hole of the connector and is engaged with the engaging surface of the connector so that the chainwheel is combined with the mandrel through the connector. Each of the two cranks has an end portion provided with a successively serrated locking bore locked onto a respective one of the urging portions of the mandrel to lock each of the two cranks onto the respective urging portion of the mandrel. The locking hole of the connector has a side provided with a protruding locking portion inserted into the fixing hole of the chainwheel. The locking portion and the mounting portion of the connector are located at the same side. The locking hole of the connector is a threaded hole, and the crank assembly further comprises a threaded fastening member screwed into the locking hole of the connector and abutting the chainwheel so that the chainwheel is sandwiched between the fastening member and the connector.

According to the primary advantage of the present invention, the mounting portion of the connector is inserted into the shaft hole of the chainwheel, and one of the two urging portions of the mandrel is extended through the mounting portion and the mounting hole of the connector and is engaged with the engaging surface of the connector so that the chainwheel is combined with the mandrel through the connector so as to enhance the structural strength of combination of the chainwheel, the mandrel and the two cranks.

According to another advantage of the present invention, the connector is available for the chainwheel of a common specification and size so as to decrease the cost of fabrication and to enhance the versatility of the crank assembly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a crank assembly in accordance with the preferred embodiment of the present invention.

FIG. 2 is an exploded perspective view of the crank assembly as shown in FIG. 1.

FIG. 3 is a cross-sectional view of the crank assembly as shown in FIG. 1.

FIG. 4 is a perspective view of a conventional crank assembly in accordance with the prior art.

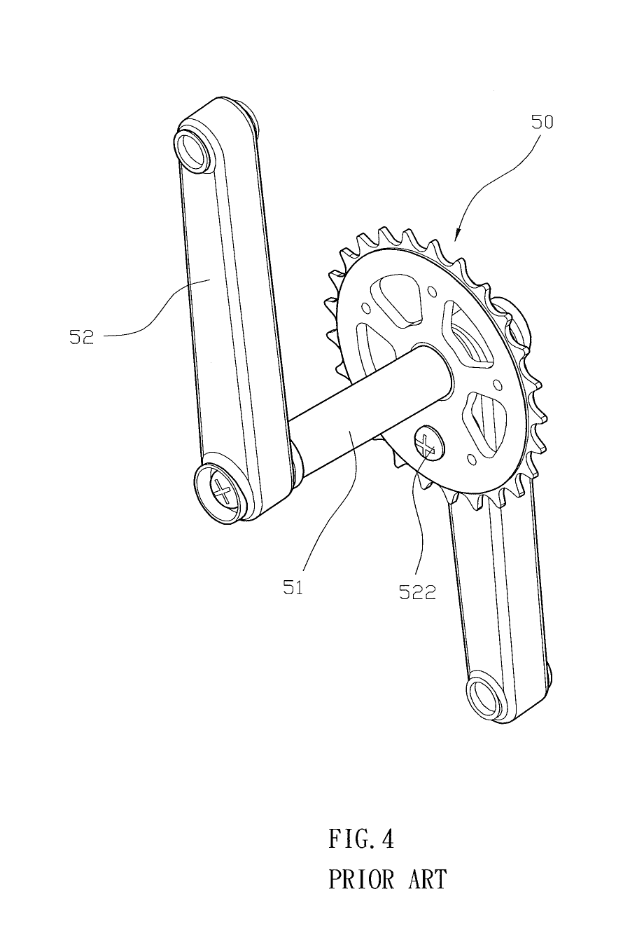

FIG. 5 is an exploded perspective view of the conventional crank assembly as shown in FIG. 4.

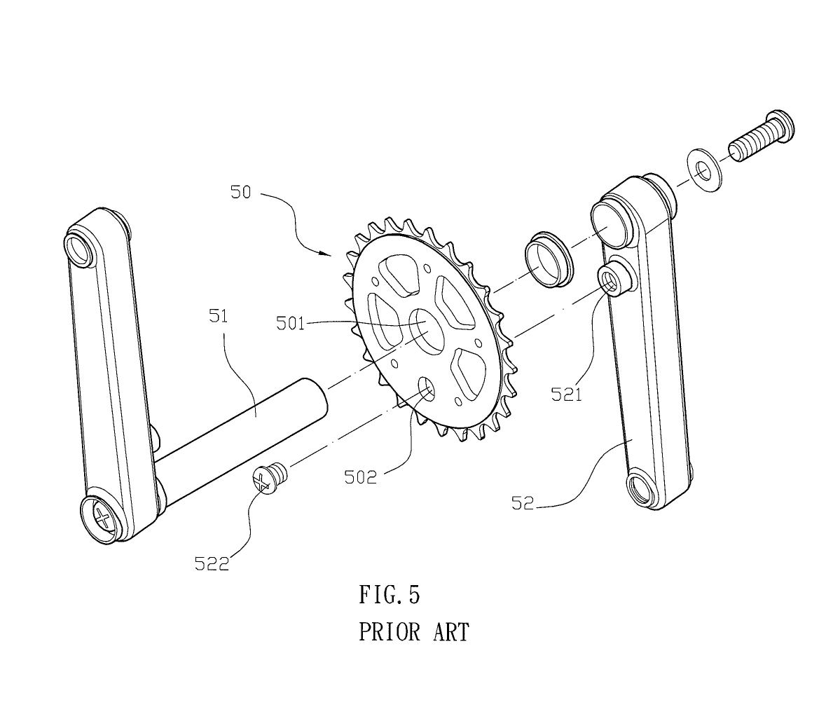

### DETAILED DESCRIPTION OF THE INVENTION

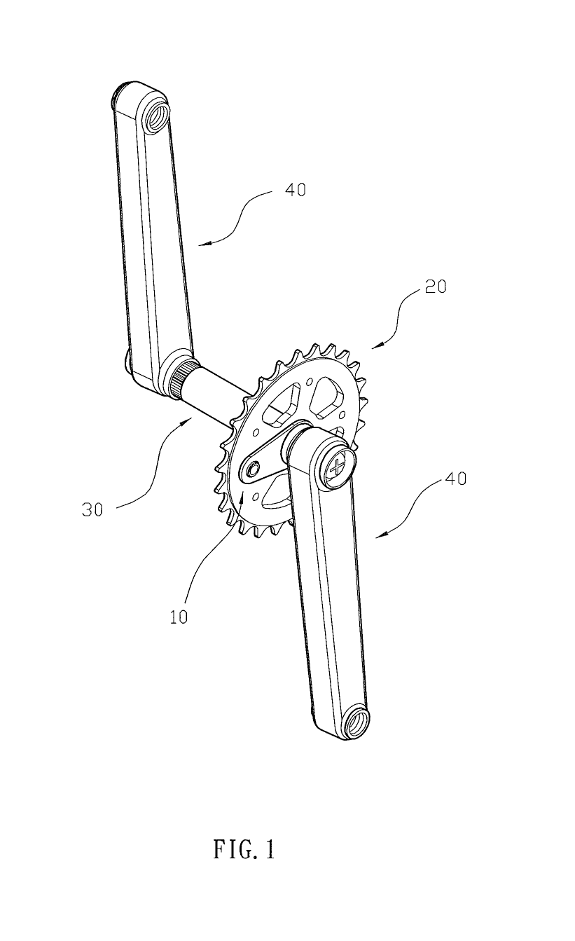

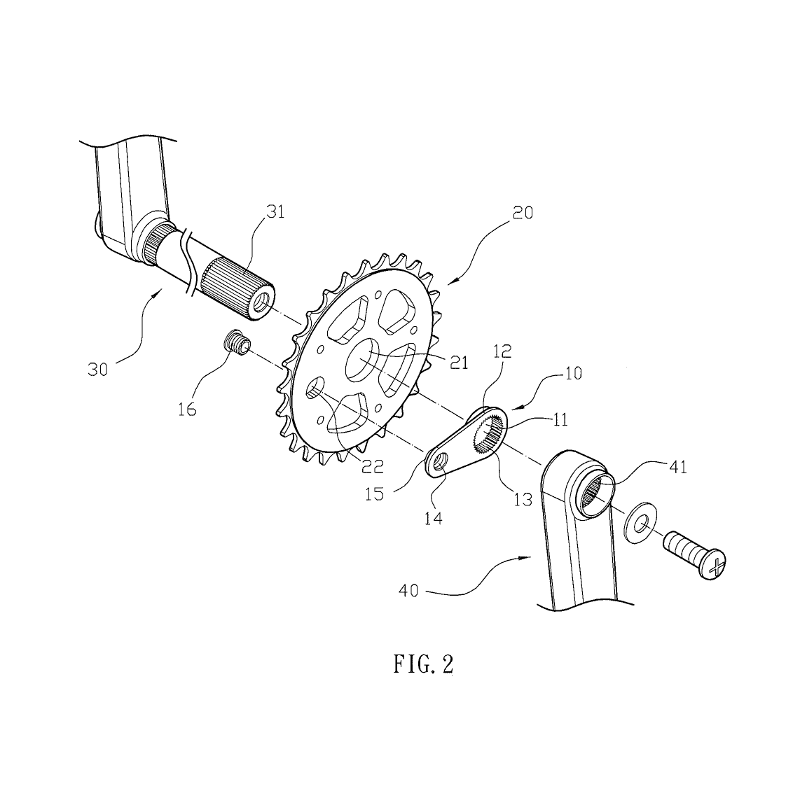

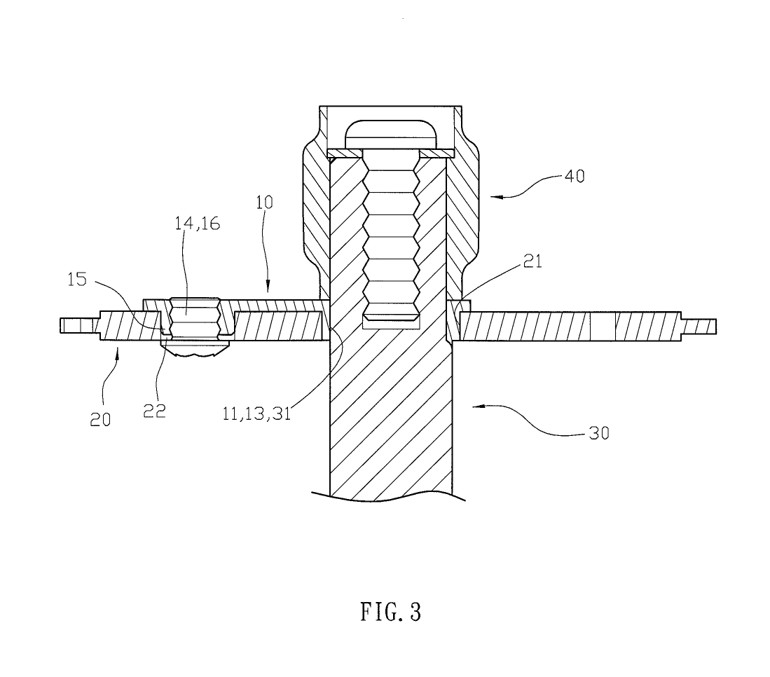

Referring to FIGS. 1-3, a crank assembly for an acrobatic bicycle in accordance with the preferred embodiment of the present invention comprises a mandrel 30, two cranks 40 mounted on the mandrel 30, a chainwheel 20 mounted on the mandrel 30 and located between the two cranks 40, and a connector 10 mounted on the mandrel 30 and located between the chainwheel 20 and one of the two cranks 40. Thus, the connector 10 is directly connected with the chainwheel 20 and located between the chainwheel 20, the mandrel 30 and one of the two cranks 40 to enhance a structural strength of combination of the chainwheel 20, the mandrel 30 and the two cranks 40 and to decrease the cost of the crank assembly.

The chainwheel 20 has a central portion provided with a shaft hole 21 and has a periphery provided with a fixing hole 22.

The connector 10 has a first end provided with a mounting hole 11 connected with the shaft hole 21 of the chainwheel 20 and a second end provided with a locking hole 14 connected with the fixing hole 22 of the chainwheel 20. The locking hole 14 of the connector 10 has a diameter smaller than that of the mounting hole 11. The mounting hole 11 of the connector 10 has a side provided with a protruding mounting portion 12 inserted into the shaft hole 21 of the chainwheel 20. The mounting hole 11 of the connector 10 has a peripheral wall provided with a successively serrated engaging surface 13 extending through the mounting hole 11 and the mounting portion 12. The locking hole 14 of the connector 10 has a side provided with a protruding locking portion 15 inserted into the fixing hole 22 of the chainwheel 20. The locking portion 15 and the mounting portion 12 of the connector 10 are located at the same side. The locking hole 14 of the connector 10 is a threaded hole, and the crank assembly further comprises a threaded fastening member 16 screwed into the locking hole 14 of the connector 10 and abutting the chainwheel 20 so that the chainwheel 20 is sandwiched between the fastening member 16 and the connector 10.

The mandrel 30 has two successively serrated urging portions 31 formed on two opposite ends thereof. One of the two urging portions 31 of the mandrel 30 is extended through the mounting portion 12 and the mounting hole 11 of the connector 10 and is engaged with the engaging surface 13 of the connector 10 so that the chainwheel 20 is combined with the mandrel 30 through the connector 10.

Each of the two cranks 40 has an end portion provided with a successively serrated locking bore 41 locked onto a respective one of the urging portions 31 of the mandrel 30 to lock each of the two cranks 40 onto the respective urging portion 31 of the mandrel 30.

Accordingly, the mounting portion 12 of the connector 10 is inserted into the shaft hole 21 of the chainwheel 20, and one of the two urging portions 31 of the mandrel 30 is extended through the mounting portion 12 and the mounting hole 11 of the connector 10 and is engaged with the engaging surface 13 of the connector 10 so that the chainwheel 20 is combined with the mandrel 30 through the connector 10 so as to enhance the structural strength of combination of the chainwheel 20, the mandrel 30 and the two cranks 40. In addition, the connector 10 is available for the chainwheel 20 of a common specification and size so as to decrease the cost of fabrication and to enhance the versatility of the crank assembly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A crank assembly, comprising:
a mandrel;
two cranks mounted on the mandrel;
a chainwheel mounted on the mandrel and located between the two cranks; and
a connector mounted on the mandrel and located between the chainwheel and one of the two cranks;
wherein the chainwheel has a central portion provided with a shaft hole and has a periphery provided with a fixing hole;
the connector has a first end provided with a mounting hole connected with the shaft hole of the chainwheel and a second end provided with a locking hole connected with the fixing hole of the chainwheel;
the locking hole of the connector has a diameter smaller than that of the mounting hole;
the mounting hole of the connector has a side provided with a protruding mounting portion inserted into and flush with the shaft hole of the chainwheel;
the mounting hole of the connector has a peripheral wall provided with a successively serrated engaging surface extending through the mounting hole and the mounting portion;
the connector is directly connected with the chainwheel and located between the chainwheel, the mandrel and one of the two cranks to enhance a structural strength of combination of the chainwheel, the mandrel and the two cranks and to decrease cost of the crank assembly.

2. The crank assembly of claim 1, wherein
the engaging surface of the connector extends through a total thickness of the mounting hole and the mounting portion;
the mandrel has two successively serrated urging portions formed on two opposite ends thereof;
one of the two urging portions of the mandrel is extended through the mounting portion and the mounting hole of the connector and is engaged with the engaging surface of the connector so that the chainwheel is combined with the mandrel through the connector.

3. The crank assembly of claim 1, wherein each of the two cranks has an end portion having an inner periphery provided with a successively serrated locking bore locked onto a respective one of the urging portions of the mandrel to lock each of the two cranks onto the respective urging portion of the mandrel.

4. The crank assembly of claim 1, wherein
the locking hole of the connector has a side provided with a protruding locking portion inserted into and locked in the fixing hole of the chainwheel;
the locking portion and the mounting portion of the connector are located at the same side.

5. The crank assembly of claim 1, wherein
the locking hole of the connector is a threaded hole; and
the crank assembly further comprises a threaded fastening member screwed into the locking hole of the connector and abutting a side of the chainwheel so that the chainwheel is sandwiched between the fastening member and the connector.

6. The crank assembly of claim 1, wherein the connector and each of the two cranks are separate elements.

7. The crank assembly of claim 1, wherein the connector is separated from each of the two cranks.

8. The crank assembly of claim 1, wherein the mounting portion of the connector is separated from each of the two cranks.

9. The crank assembly of claim 1, wherein the mounting portion of the connector is detachable from one of the two cranks.
